(19) United States
(12) Patent Application Publication
(10) Pub. No.: US 2012/0180287 A1
(43) Pub. Date: Jul. 19, 2012

(54) GUIDED PUNCH FOR FASTENER REMOVAL

(76) Inventor: Mervyn Rudgley, Mission Viejo, CA (US)

(21) Appl. No.: 13/349,085

(22) Filed: Jan. 12, 2012

Related U.S. Application Data
(60) Provisional application No. 61/461,121, filed on Jan. 13, 2011.

(51) Int. Cl. B25B 27/14; B23P 11/00

(52) U.S. Cl. 29/426.4; 29/275; 29/426.5

(57) ABSTRACT

Devices and methods for removing a partially severed fastener by mating a retractable shaped neck (220) on a latching guide (200) to a corresponding recess (26) in a partially severed fastener (20), said fastener being fixed in a workpiece (40) and extending a punch head (114) through said shaped neck (via retracting of said shaped neck) and transferring a force from said punch to said fastener thereby severing the shank (24) portion of the fastener from other portions of the fastener are disclosed.

### RELATED APPLICATIONS

This application claims the full Paris Convention benefit of and priority to U.S. Provisional Patent Application Ser. No. 61/461,121 filed Jan. 13, 2011, the contents of which is incorporated herein by reference in its entirety, as if fully set forth herein.

### BACKGROUND

1. Field

This disclosure relates to devices and methods for directing force to the head, or a portion thereof, of a fastener.

2. Description

According to some exemplary implementations, disclosed is a method to break and/or remove partially severed fasteners by mating a punch device having a retracting latching guide with an extended shaped neck into a corresponding recess in a partially severed fastener, said fastener being fixed in a workpiece and then applying force to the punch device whereby a punch head within said retracting latching guide is extended. During retraction of said latching guide, the exposed punch head transfers force to said fastener and breaks apart the partially severed fastener. The shaped neck is retractable to expose said punch head and may be supported on a spring or other flexible support. Upon impact, said shaped neck extends through a retaining aperture in a collar which is placed on said handle.

According to some exemplary implementations, the recess which mates to the punch device is in the fastener head; in other implementations, it may be in the fastener collar.

According to some exemplary implementations, the shaped recess and the shaped neck are substantially circular. In other implementations, the shaped recess and the shaped neck are substantially geometric and non-circular.

According to some exemplary implementations, a non-skid punch having a punch head at its distal tip and a proximal end affixed to a handle with a spring surrounding a portion of said punch and supporting a retractable latching guide is disclosed. Said latching guide has a shaped neck affixed retractably around a portion of said punch and said spring. A collar or other retaining fixture (i.e. a sleeve, body part or the like) with an open back end is affixed to said handle, and said collar has an aperture at its front end of a size and shape to allow said shaped neck to extend (prior to retraction) outward beyond said distal tip, said collar surrounding said punch, spring, and latching guide.

According to some exemplary implementations, the shape and size of the shaped neck of the latching guide corresponds to the shape and size of a recess in a partially severed fastener. In some instances, the shape and size of the recess and the shaped neck are substantially circular. In some instances the shape and size of the recess and the shaped neck are substantially geometric and non-circular.

### DRAWINGS

The above-mentioned features and objects of the present disclosure will become more apparent with reference to the following description taken in conjunction with the accompanying drawings, wherein like reference numerals denote like elements and in which:

FIG. 1 shows an assembly view of a guided punch.

FIGS. 2A and 2B show a cross-sectional view of a guided punch, fastener, and workpiece.

FIG. 3 shows a cross-sectional view of a guided punch, on a fastener.

FIGS. 4A and 4B shows a cross-sectional view of a guided punch, after severing a fastener from a workpiece.

All descriptions and callouts in the Figures are hereby incorporated by this reference as if fully set forth herein.

### FURTHER DESCRIPTION

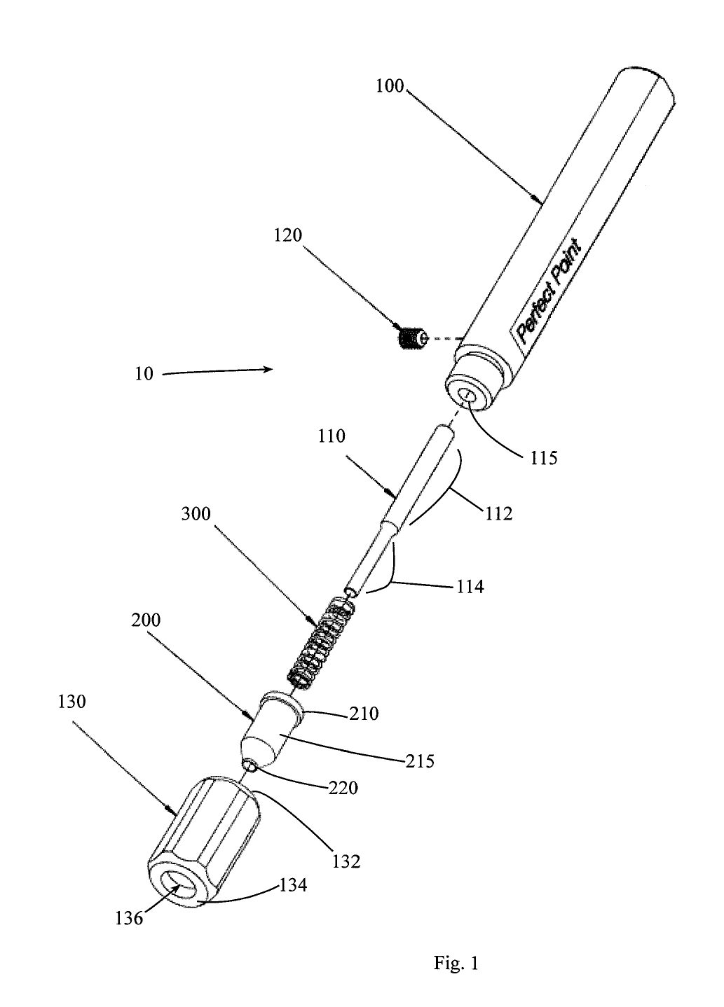

According to exemplary implementations, a non-skid punch device and method is disclosed herein. The non-skid punch device 10 in some exemplary implementations has a handle 100 (see FIGS. 1-4). Handle 100 may vary in many forms. The handle should be of a size and shape to allow it to be hand-held. The handle should be constructed of a material which can withstand multiple impacts of a piston, hammer, mallet, or the like. The material should not shatter, bend or substantially deform upon repeated impact.

Punch 110 (if separate from the handle) fits into handle 100 via a guide 115 and is fixed in the guide with locking screw 120 (that is inserted into a guide in said handle not shown). Punch 110 has a punch body 112 portion at its proximal end, said punch body fitting into the guide 115 and a punch head 114 with a distal tip (that will engage fasteners) remote from the handle. Those of ordinary skill in the art will recognize that said punch and handle may be formed or machined as a single unit, without departing from the scope of the disclosure.

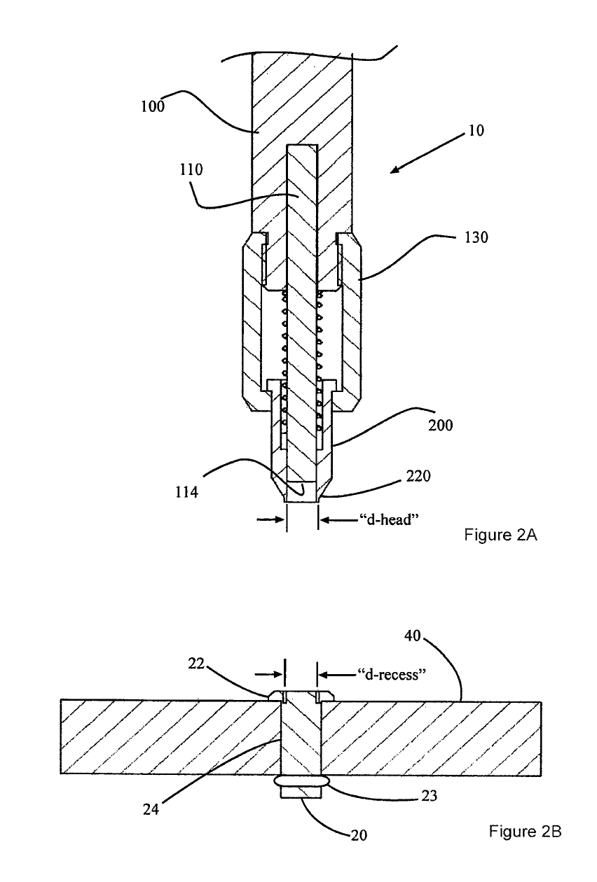

Floating centering guide latch 200 movable fits onto punch head 114. Spring 300 is interposed between the inner wall of the floating centering guide latch 200 and the punch 110 whereby, as illustrated in FIGS. 2-5, the floating guide latch can move axially along the punch if said floating guide latch 200 is depressed and retracts. The floating guide latch 200 is hollow and it has a base 210 which is wider than its body 215. It also has a shaped neck 220 opposite the base. The shaped neck may be circular, ovoid, geometric, or other complex shapes which mate with a recess or channel in a partially severed fastener.

To assemble the non-skid punch device 10 a collar 130 with an open back end and front end 134 with a retaining aperture 136 smaller than the diameter of base 210 of the centering floating guide latch 200 the collar 130 which contains and holds the floating guide latch, spring and punch in the afore described arrangement is secured to the forward end 140 of the handle via one or more of threads, weld, solder, glue, friction fit and latch/catch. The secure mount maybe permanent or removable.

FIGS. 2A and 2B show the device 10 positioned above fastener 20 which is affixed to a workpiece 40. The fastener has a head portion 22, a fastener collar (or in some cases sleeve) 23 and a shank portion 24. Those of ordinary skill in the art will recognize that there are many types of fixtures that may be used to attached fasteners including sleeves, nuts, swag devices and the like, and such fixtures are within the scope of this disclosure, some of which are generally described in PCT application PCT/US10/55316, filed Nov. 2, 2010 which is hereby incorporated herein by reference, as if fully set forth herein.

Prior to the use of the device 10 for removing some fixed fasteners, a ring shaped recess 26 is shown eroded in the head 22 of the fastener. Methods to erode said ring are generally set forth in U.S. patent application Ser. No. 12/603,507, filed Oct. 21, 2009, which is hereby incorporated by reference as if fully set forth herein. The shaped neck 220 of the floating centering guide latch 200 is hollow and has a diameter “d head”. When the shaped recess 26 formed in the head portion 22 of the fastener corresponds to the shaped neck 220, the shaped neck mates with the shaped recess thereby limiting movement of the punch device 10 due to slippage across the workpiece of the head portion 22. The punch head 114 is positioned within the centering floating guide latch 200 above the fastener 20.

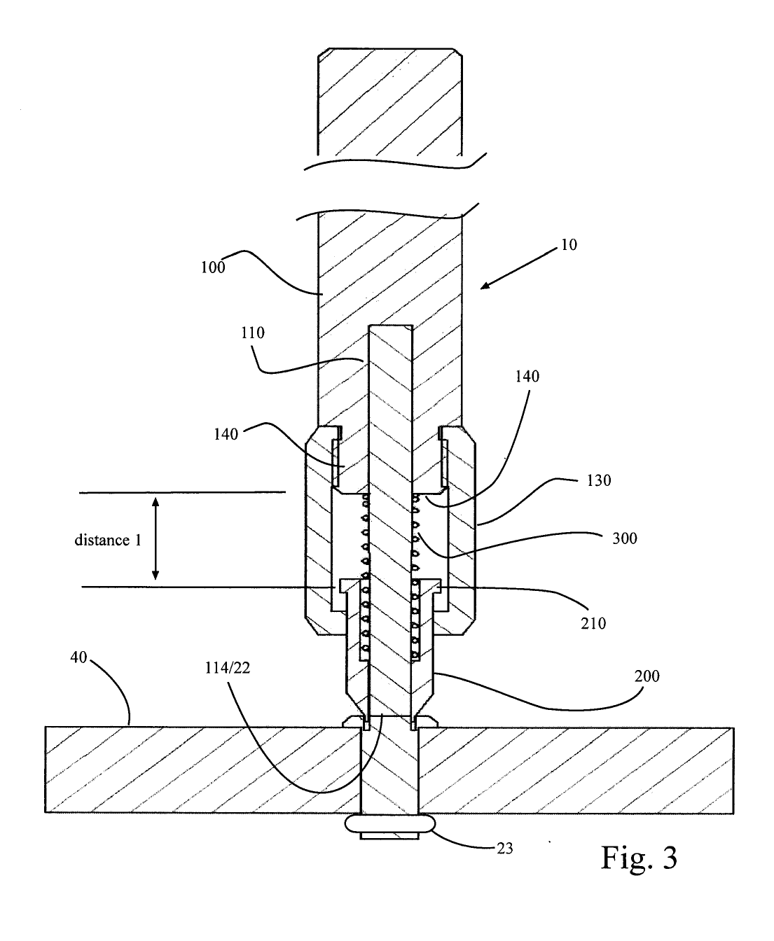

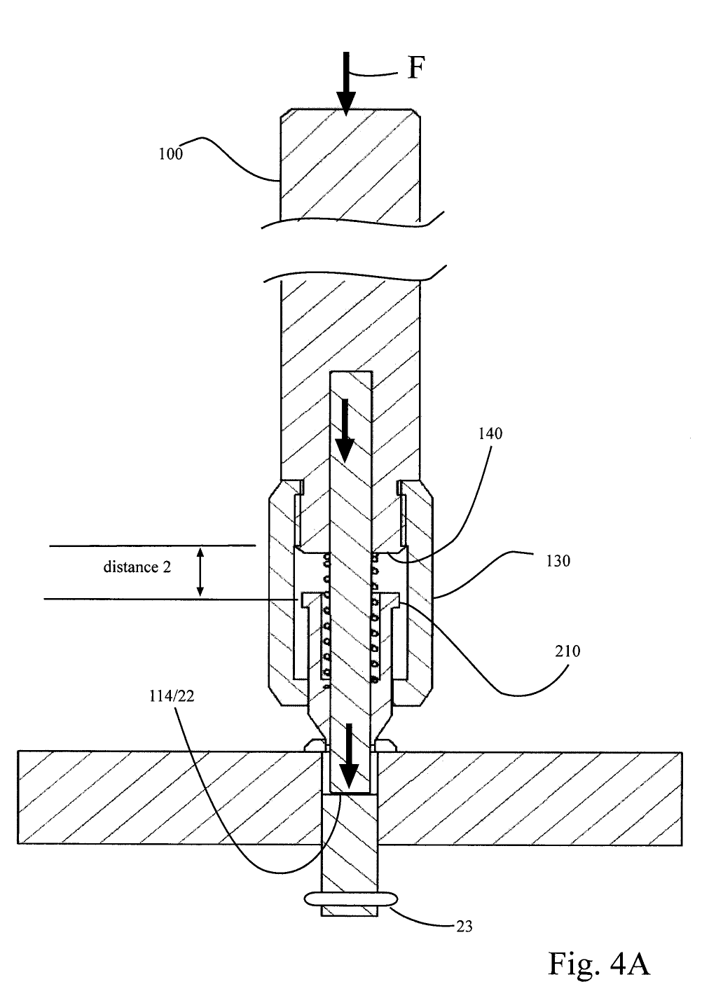

FIG. 3 shows the non-skid punch device 10 wherein shaped neck 220 is mated with the shaped recess 26. The mated the end of the punch head 114 rests on or near the head portion 22 of the fastener. Before force (i.e. a strike or impact to its handle end) is added to the non-skid punch device 10 distance 1 describes the separation of floating guide latch 200 and the forward end 140 of the handle.

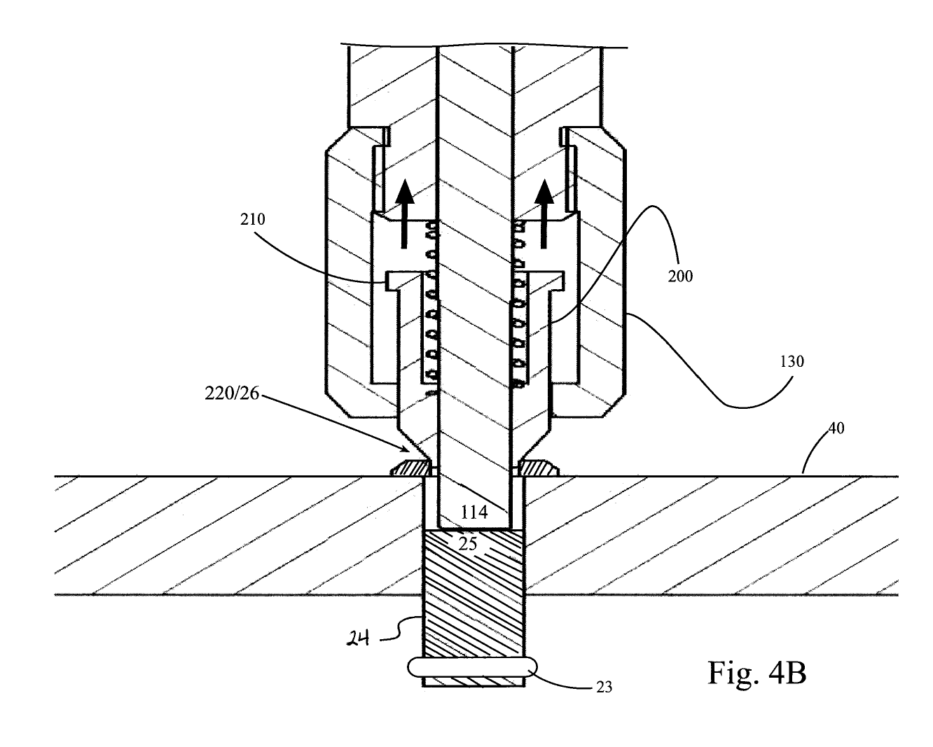

FIGS. 4A and 4B show the non-skid punch device 10 wherein force “F” has been applied to the handle and the punch head 114 has been driven downward against a central area 25 of the head portion 22 of the fastener 20 thereby severing the central area 25 and shank portion 24 from the head portion 22. The non-skid punch device 10 remains at the fastener head portion 22 in said recess 26 which acts as a catch. Upon impact, the floating guide latch's shaped neck 220 retracts into the collar 130 by compressing the spring 300, said floating guide latch, and spring within said collar. Distance 2 describes the reduced separation of floating guide latch 200 and the forward end 140 of the handle after force was applied. Once separated, the shank portion 24 may be disassociated from the workpiece 40.

While the method and apparatus have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A partially severed fastener removal method, the method comprising:
mating a punch device (110) having a retracting floating guide latch (200) with a shaped neck (220) to a corresponding recess (26) in a partially severed fastener (20), said fastener being fixed in a workpiece (40);
applying force to punch device (110) whereby a punch head (114) within said retracting floating guide latch (200) is extended during retraction of said floating guide latch (200); and,
applying said exposed punch head (114) to said partially severed fastener wherein the force applied to said punch (110) is transferred to said fastener and separates said partially severed fastener at the control area (25).

2. The method of claim 1 wherein the fastener has a head portion (22), a collar portion (23) and a shank portion (24) and said recess (26) is formed in said head portion.

3. The method of claim 1 wherein the fastener has a head portion (22), a collar portion (23) and a shank portion (24) and said recess (26) is formed in said collar portion.

4. The method of claim 1 wherein the shaped recess (26) and the shaped neck (220) are substantially circular.

5. The method of claim 1 wherein the shaped recess (26) and the shaped neck (220) are substantially geometric and non-circular.

6. The method of claim 1 wherein the shaped neck (220) is movably on a spring and said shaped neck extends through a retaining aperture in a collar which on said handle.

7. A non-skid punch comprising:
a punch (110) having a punch head (114) at its distal tip and a punch body (122) affixed to a handle;
a spring (300) surrounding a portion of said punch;
a floating guide latch (200) with a shaped neck (220) affixed retractably around a portion of said punch and said spring; and,
a collar (130) with an open back end that affixes to said handle and an aperture (136) at its front end (134) of a size and shape to allow said shaped neck (220) to extend outward beyond said distal tip, said collar surrounding said punch, spring and latching guide.

8. The punch of claim 7 wherein the shape and size of the shaped neck of the latching guide corresponds to the shape and size of a recess (26) in a partially severed head (22) of a fastener (20).

9. The punch of claim 8 wherein the shape and size of the recess (26) and the shaped neck (220) are substantially circular.

10. The punch of claim 8 wherein the shape and size of the recess (26) and the shaped neck (220) are substantially geometric and non-circular.

11. The punch of claim 7 further comprising a locking screw (120) that fits into a guide in said handle said screw affixing said punch (110) into said handle (100).

12. A method to remove fasteners, the method comprising:
identifying a recess (26) in the head of a fastener (20) which is affixed to a workpiece (40);
mating a shaped neck (220), corresponding to said recess, of a punch device (10) having a retracting latching guide (200) to said recess (26) in said fastener (20);
applying force to a punch body (112) device whereby a punch head (114) within said retracting latching guide is extended during retraction of said latching guide; and,
applying said exposed punch head (114) to said fastener wherein the force applied to said punch is transferred to said fastener.

13. The method of claim 12 wherein the shaped recess (26) and the shaped neck are substantially circular.

14. The method of claim 12 wherein the head (22) of the fastener is partially severed via said recess.

15. The method of claim 14 wherein the force applied severs the partially severed head (22) at the control area (25).
